(19) United States
(12) Patent Application Publication
(10) Pub. No.: US 2011/0100763 A1
(43) Pub. Date: May 5, 2011

(54) Interlocking Elevator Cab Assembly

(76) Inventors: Tom Wiacek, North Aurora, IL (US); John Heuer, Holly Springs, MS (US)

(21) Appl. No.: 12/882,284

(22) Filed: Sep. 15, 2010

Related U.S. Application Data
(60) Provisional application No. 61/242,520, filed on Sep. 15, 2009.

(51) Int. Cl. B66B 11/02; B23P 11/00

(52) U.S. Cl. 187/401; 29/428

(57) ABSTRACT

Provided is an elevator cab assembly having a number of alternating and interlocking columns and panels, both of which may be prefabricated. The alternating and interlocking columns and panels are combined with an elevator platform and an elevator canopy to complete the elevator cab assembly. Because a minimal number of fasteners are required for assembly, the invention reduces the time required for construction and installation of cab. Furthermore, the assembly may be assembled on the elevator platform through the finished opening of the elevator entrance. A method of assembling the cab is also provided.

### FIELD

Embodiments of the present invention relate, in general, to an elevator cab assembly, and, in particular, to a system and method of assembling prefabricated cab components.

### BACKGROUND

An elevator cab assembly generally comprises a bottom platform, a ceiling canopy, and a series of wall panels and columns that make up the cab walls. The elevator paneling typically includes steel or laminated panels that are fastened together via screws, nuts and bolts, or other specialty connections. During assembly of an elevator cab, it may be necessary to pre-assemble some of the components of the cab, i.e., the side and back wall panels. Such pre-assembly may be required because the fasteners and tools used to join the components may not be easily accessible in an elevator shaft. Reducing the amount of pre-assembly required to construct an elevator cab may result in corresponding reductions in manufacturing and installation time.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings. In the drawings, like numerals represent like elements throughout the several views.

FIG. 1 is a perspective view of one version of an elevator cab assembly.

FIG. 2a is a perspective view of a front-corner column of the cab assembly of FIG. 1.

FIG. 2b is a side elevational view of the front-corner column of FIG. 2a.

FIG. 2c is a front elevational view of the front-corner column of FIG. 2a.

FIG. 2d is a top plan view of the front-corner column of FIG. 2a.

FIG. 3a is a perspective view of a side column of the cab assembly of FIG. 1.

FIG. 3b is a side elevational view of the side column of FIG. 3a.

FIG. 3c is a front elevational view of the side column of FIG. 3a.

FIG. 3d is a top plan view of the side column of FIG. 3a.

FIG. 4a is a perspective view of a back-corner column of the cab assembly of FIG. 1.

FIG. 4b is a side elevational view of the back-corner column of FIG. 4a.

FIG. 4c is a front elevational view of the back-corner column of FIG. 4a.

FIG. 4d is a top plan view of the back-corner column of FIG. 4a.

FIG. 5 is an exploded view of the cab assembly of FIG. 1.

FIG. 6 is an exploded view of the front-corner column of FIG. 2a showing a fastener associated with an elevator platform.

FIG. 7 is a partial perspective view of the cab assembly of FIG. 1.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples should not be used to limit the scope of the present invention. Other features, aspects, and advantages of the versions disclosed herein will become apparent to those skilled in the art from the following description, which is by way of illustration, one of the best modes contemplated for carrying out the invention. As will be realized, the versions described herein are capable of other different and obvious aspects, all without departing from the invention. Accordingly, the drawings and descriptions should be regarded as illustrative in nature and not restrictive. As used herein the terms “front” and “back” will be understood to refer to position relative to the elevator cab. As will be understood by one of ordinary skill in the art, however, the use of such positional terms should not be used to limit the present application.

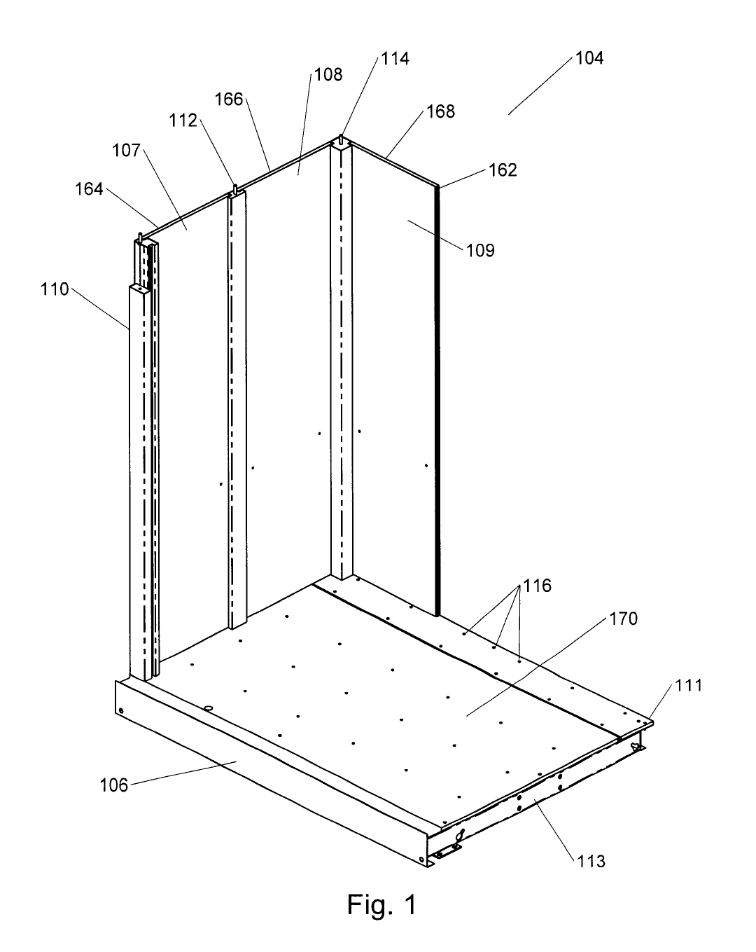

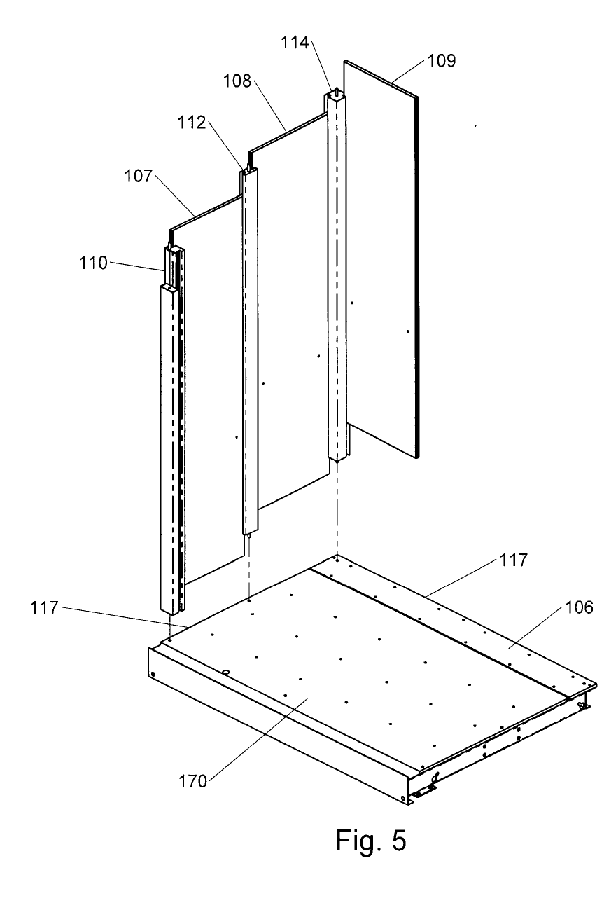

As shown in FIGS. 1-7, one version of an elevator cab assembly (104) may include an elevator platform (106), wall panels (107, 108, 109), and columns (110, 112, 114). In particular, the wall panels (107, 108, 109) and columns (110, 112, 114) may be prefabricated and cut to interlock with each other, such as in a tongue and groove manner, and with the platform (106) for ease of construction and installation. Referring to FIG. 1, an exemplary elevator cab assembly (104) is shown. In the illustrated version, the cab assembly (104) comprises an elevator platform (106), wall panels (107, 108, 109), and columns (110, 112, 114). Although the present example depicts three panels (107, 108, 109) and three columns (110, 112, 114), it should be understood that assembly (104) may comprise any suitable number of panels and/or columns to enclose the walls of an elevator cab. In the illustrated version, a complete cab assembly (not pictured) includes eight panels and eight columns. As shown in the figures, the elevator platform (106) has a generally planar rectangular shape suitable to serve as the floor of an elevator cab. As shown in FIG. 5, platform (106) is defined by an interior area (170) and edges (117). Platform (106) should not be limited to a generally planar rectangular shape as platform (106) may take on any shape or form suitable for the floor of an elevator cab. In the present example, platform (106) comprises two layers, a plywood sub-floor (111) and a metal underlying structure (113). Platform (106) also comprises a plurality of pre-formed, pre-punched, or pre-drilled mounting holes (116) into which the columns (110, 112, 114) and/or wall panels (107, 108, 109) may be inserted to assemble the elevator cab (104). Mounting holes (116) may pass through the sub-floor (111), the metal floor (113), or both. Platform (106) may include any suitable number of mounting holes, apertures, or couplings in any suitable arrangement.

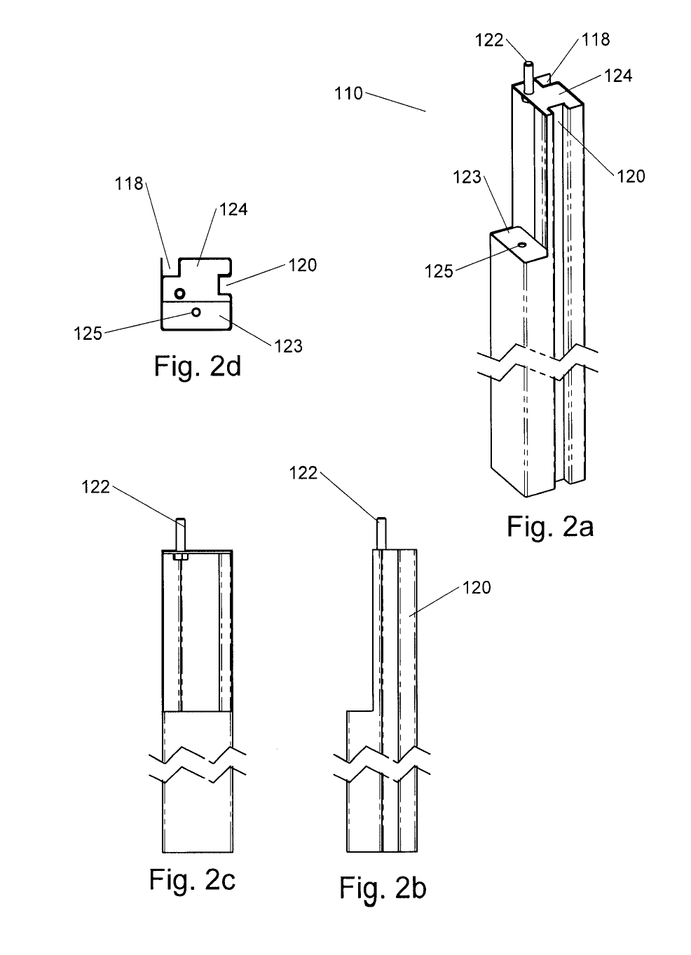

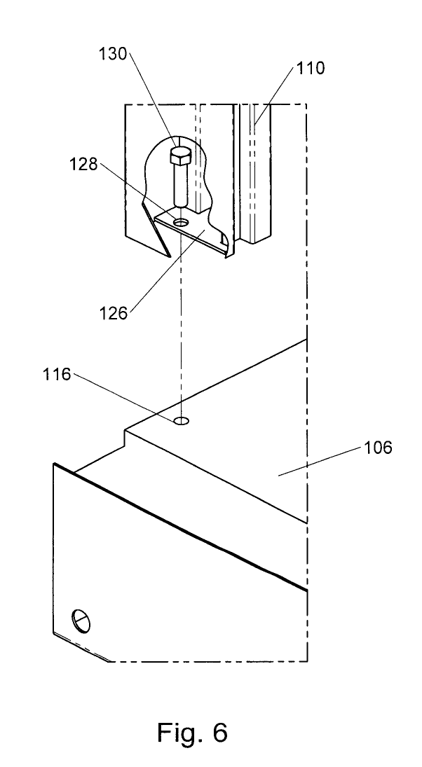

Referring to FIGS. 2-4, columns (110, 112, 114) are shown in greater detail. Columns (110, 112, 114) may be pre-fabricated and fashioned to interlock with wall panels (107, 108, 109) and the platform (106) for ease in constructing and installing the elevator cab assembly (104). Column (110) is a front-corner column of the assembly (104). As shown in FIGS. 2a-2d, column (110) comprises grooves (118, 120) and a post (122). Grooves (118, 120) are cutouts that run along the longitudinal length of column (110) and into which wall panels (107, 108, 109) may be inserted in an interlocking fashion for quick assembly of the cab (104). Post (122) extends from a top surface (124) of column (110) and may be inserted into a hole or cavity in a ceiling canopy structure (not pictured) to complete the assembly of the cab (104). In addition, column (110) may be secured to platform (106) in any suitable fashion. In the exemplary version, as shown in FIG. 6, column (110) further comprises a base (126) having a hole (128) into which a fastener (130) may be inserted to secure column (110) to platform (106). In the present example, fastener (130) is a bolt, but it should be understood that fastener (130) may be any other suitable means of securing the column (110) to the platform (106) including a screw, nail, post, staple, glue/adhesive, and/or any other suitable fastener having any suitable shape. To mount and secure an elevator door operator assembly (not pictured), column (110) may also comprise a ridge (123) that includes a mounting hole (125).

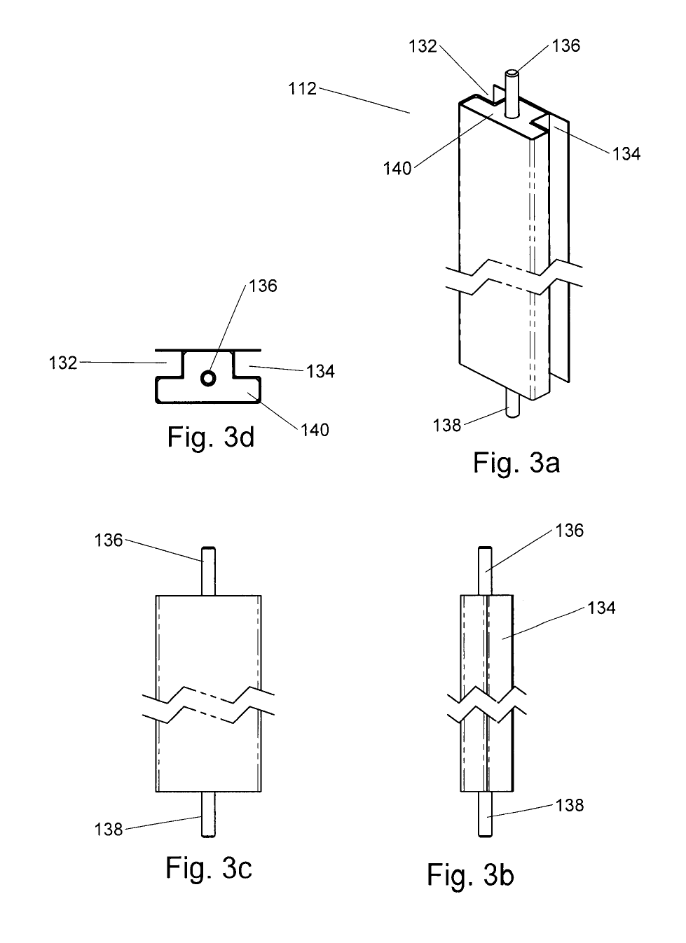

Column (112) is an exemplary version of a side column of the cab assembly (104). As shown in FIGS. 3a-3d, column (112) has a T-shaped cross-section and comprises grooves (132, 134) and posts (136, 138). Grooves (132, 134) are cutouts that run along the longitudinal length of column (112) and into which wall panels (107, 108, 109) may be inserted in an interlocking fashion for quick assembly of the cab (104). Post (136) extends from a top surface (140) of column (112) and may be inserted into a hole or cavity in a ceiling canopy structure (not pictured) to complete the assembly of the cab (104). In similar fashion, post (138) extends from a bottom surface of column (112) and may be inserted into a mounting hole (116) in platform (106) to secure column (112) to platform (106). Of course, column (112) may be secured to platform (106) in any other suitable manner. By way of example only, column (112) may be secured using a fastener (130), such as the bolt shown in FIG. 6.

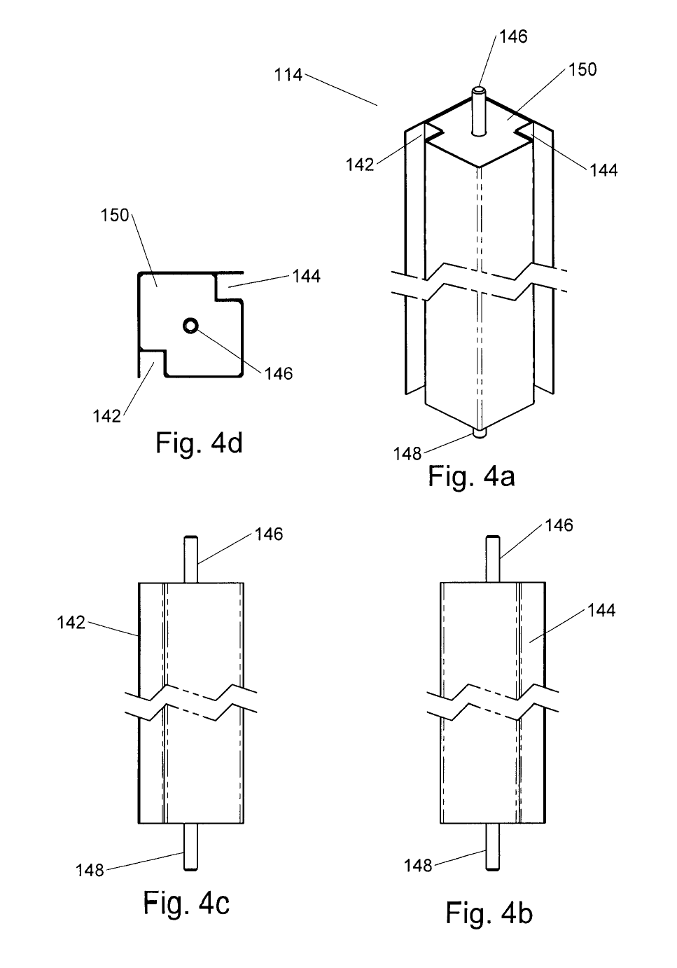

Column (114) is an exemplary version of a back-corner column of the cab assembly (104). As shown in FIGS. 4a-4d, column (114) comprises a coupling such as, for example, grooves (142, 144) and posts (146, 148). Grooves (142, 144) are cutouts that run along the longitudinal length of column (114) and into which wall panels (107, 108, 109) may be inserted in an interlocking fashion for quick assembly of the cab (104). Post (146) extends from a top surface (150) of column (114) and may be inserted into a hole or cavity in a ceiling canopy structure (not pictured) to complete the assembly of the cab (104). In similar fashion, post (148) extends from a bottom surface of column (114) and may be inserted, for example, into a mounting hole (116) in platform (106) to secure column (114) to platform (106). Of course, column (114) may be secured to platform (106) in any other suitable manner. By way of example only, column (114) may be secured using a fastener (130), such as the bolt shown in FIG. 6.

As shown in the figures, the columns each comprise two grooves and one or two posts, but it will be appreciated that the columns may include any suitable number of grooves and/or posts as may be necessary or desired in the cab assembly (104). For example, a column may comprise a third groove to permit the column to interlock with three wall panels. It will be appreciated that the tongue and groove coupling is shown by way of example only, where any suitable coupling arrangement between the columns and wall panels and between the columns and platform and ceiling panel is contemplated.

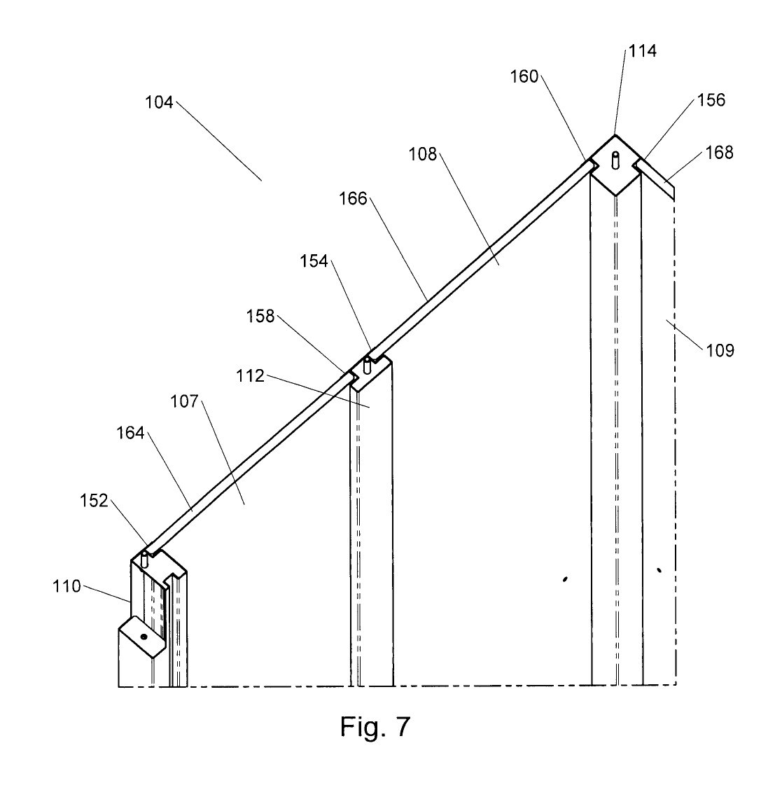

Wall panels (107, 108, 109) are generally planar and rectangular in shape such that they fit into the grooves (118, 120, 132, 134, 142, 144) of columns (110, 112, 114) to assemble the cab (104). As shown in FIG. 7, wall panels (107, 108, 109) may have a first end (152, 154, 156) and a second end (158, 160, 162) configured to engage the grooves (118, 120, 132, 134, 142, 144). In this way, panels (107, 108, 109) may be secured to the assembly (104) in a tongue and groove manner. In addition, panels (107, 108, 109) may have top edges (164, 166, 168) that may be secured to a ceiling canopy (not pictured). Although not shown in the illustrated version, panels (107, 108, 109) may also be secured to the platform (106) in any suitable manner including, for example, with fasteners such as a bolt, screw, nail, post, staple, and/or a glue/adhesive. The wall panels (107, 108, 109) may, for example, be attached to the platform (106) and/or columns (110, 112), 114) with one or a plurality of posts similar to posts (122, 136, 138, 146, 148).

Of course, the above-described elevator cab assembly (104) is merely one example. Any other suitable type of cab assembly (104) and associated components may be used. Although the column (110) is shown with a male coupling adapted to engage a female coupling in platform (106), it will be appreciated that the male coupling may be associated with platform (106) and the female coupling with column (110). Alternatively, cab assembly (104) may have any other suitable components, features, configurations, functionalities, operability, etc. The posts may comprise a welded bolt and/or nut. Other suitable variations of control module (104) and associated components will be apparent to those of ordinary skill in the art in view of the teachings herein.

Referring to FIGS. 5-7, cab assembly (104) is shown. Due to its design of alternating and interlocking columns (110, 112, 114) and panels (107, 108, 109), both of which may be prefabricated, the time required for construction and installation of cab (104) may be reduced. Furthermore, the assembly (104) may be assembled on the elevator platform (106) through the finished opening of the elevator entrance using a minimal number of fasteners. Cab (104) may be assembled by securing columns (110, 112, 114) and wall panels (107, 108, 109) in alternating fashion around the edge (117) of platform (106). In one version of a method of assembly, column (110) may be secured to edge (117) of platform (106) by inserting fastener (130) through hole (128) in the base (126) of column (110) and into the mounting hole (116) in platform (106). Fastener (130) may then be secured, if needed, by, for example, a nut (not pictured). After column (110) is secured to platform (106), a first end (152) of wall panel (107) may be positioned within groove (118) of column (110) so that the panel (107) is aligned with the edge (117) of platform (116). The second end (158) of panel (107) may be inserted into groove (132) of column (112), and column (112) may be secured to edge (117) of platform (106). Column (112) may be secured to platform (106) by, for example, insertion of post (138) into a mounting hole (116) in platform (106).

After column (112) is secured to platform (106), a first end (154) of wall panel (108) may be positioned within groove (134) of column (112) so that panel (108) is aligned with edge (117) of platform (116). The second end (160) of panel (108) may also be inserted into groove (142) of column (114), and column (114) may be secured to edge (117) of platform (106). Column (114) may be secured to platform (106) by, for example, insertion of post (148) into a mounting hole (116) in platform (106). A side tie angle or out-rigger assembly (not pictured) may be fastened to the top edges (164, 166) of panels (107, 108) to tie the panels (107, 108) together from front to back to provide a first side wall of elevator cab (104).

After column (114) is secured to platform (106), a first end (156) of wall panel (109) may be positioned within groove (144) of column (114) so that panel (109) is aligned with edge (117) of platform (116). Following the same process, panel (109) may be held in place by inserting its second end (162) into the groove of another column (not pictured) that may be secured to platform (106). In this way, by alternating columns and wall panels around the edge (117) of platform (116), the cab assembly (104) may be completed by providing the back, front, and second side walls to the assembly (104). To complete the cab assembly (104), columns (110, 112, 114) may be secured to a top ceiling canopy, crosshead assembly, car door operator assembly, and/or an out-rigger assembly (none pictured).

It should be understood that the above-described elevator cab assembly (104) and method of assembly is merely one example. Other suitable components, features, configurations, functionalities, operability, methods, etc. for building and installing an elevator cab assembly (104) will be apparent to those of ordinary skill in the art in view of the teachings herein. By way of example only, the method of assembly described above need not be performed in any order and the method of assembly described should not be limited to the order disclosed. In addition, it should be understood that although the columns (110, 112, 114) and panels (107, 108, 109) are aligned along the edge (117) of platform (106 in the exemplary version, placement of the columns (110, 112, 114) and panels (107, 108, 109) need not be limited to those locations. For example, columns (110, 112, 114) and/or panels (107, 108, 109) may be positioned and secured along the interior (170) of platform (106). The wall panels may also be configured such that they are flush with the columns in the elevator assembly to provide a uniform interior surface.

Having shown and described various versions in the present disclosure, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. An elevator cab assembly, comprising:
a. a plurality of columns, each of the plurality of columns having a first platform coupling and a first panel coupling;
b. an elevator platform, the platform having a second platform coupling, wherein the second platform coupling is configured to engage the first platform coupling; and
c. a plurality of panels, each of the plurality of panels having a second panel coupling, wherein the second panel coupling is configured to engage the first panel coupling.

2. The elevator cab assembly of claim 1, wherein the first platform coupling is a post, the second platform coupling is an aperture, the first panel coupling is a groove, and the second panel coupling is a tongue.

3. The elevator cab assembly of claim 1, wherein the plurality of columns are configured to engage the plurality of panels to form an elevator cab.

4. The elevator cab assembly of claim 1, wherein the first platform coupling is a female coupling and the second platform coupling is a female coupling.

5. The elevator cab assembly of claim 1, wherein the plurality of panels have an identical configuration.

6. A method of assembling an elevator cab, the method comprising:
providing an elevator platform having a plurality of edges;
providing a plurality of columns, each column of the plurality of columns having at least one groove;
providing a plurality of panels, each panel of the plurality of panels having a first end and a second end;
securing a first column of the plurality of columns to a first edge of the plurality of edges of the elevator platform;
positioning the first end of the first panel of the plurality of panels into the at least one groove of the first column;
securing a second column of the plurality of columns to the first edge of the platform;
positioning the second end of the first panel of the plurality of panels into the at least one groove of the second column;
continuing to secure the plurality of columns to the plurality of edges of the elevator platform; and
continuing to position the plurality of panels into the at least one grooves of the plurality of columns.
